(19) United States
(12) Patent Application Publication
(10) Pub. No.: US 2007/0063672 A1
(43) Pub. Date: Mar. 22, 2007

(54) Rechargeable battery pack and electrical hand tool device

(76) Inventors: Bernd Wiesner, Owen (DE); Jochen Graeber, Bissingen (DE)

Correspondence Address: DREISS, FUHLENDORF, STEIMLE & BECKER, POSTFACH 10 37 62, D-70032 STUTTGART, DE

(21) Appl. No.: 11/521,393

(22) Filed: Sep. 15, 2006

(30) Foreign Application Priority Data
Sep. 20, 2005 (DE) 102005045700.2-45

(51) Int. Cl. H02J 7/00

(52) U.S. Cl. 320/116

(57) ABSTRACT

The invention concerns a rechargeable battery pack, in particular, for use with an electrical hand tool device, comprising a rechargeable battery housing, rechargeable battery cells which are disposed in the rechargeable battery housing and connected in series, and an electronic unit which is connected to the rechargeable battery cells for determining the voltage of the rechargeable battery cells. The invention also concerns a method for determining the voltages of individual rechargeable battery cells which are disposed in series in a rechargeable battery pack as well as an electrical hand tool device.

This application claims Paris Convention priority of DE 10 2005 045 700.2 filed Sep. 20, 2005 the complete disclosure of which is hereby incorporated by reference.

### BACKGROUND OF THE INVENTION

The invention concerns a rechargeable battery back, in particular, for use in an electrical hand tool device, comprising a rechargeable battery housing and rechargeable battery cells which are connected in series and disposed in the rechargeable battery housing, and an electronic unit connected to the rechargeable battery cells for detecting the voltage of the rechargeable battery cells.

Voltages have conventionally been tapped downstream of individual, series-connected, rechargeable battery cells by connecting each rechargeable battery cell to a measuring system comprising a measuring amplifier and/or an analog/digital converter.

The voltage of the individual cells must be tapped in order to monitor their charging state using an electronic monitoring circuit. When the charging state is not monitored and, if necessary, the charging current to the individual cells controlled, individual cells could be destroyed e.g. due to excessive charging currents, or individual cells of the series may not be completely recharged. Moreover, it is not possible to detect individual cells which are not recharged due to a defect. In particular, rechargeable lithium ion battery cells, which have recently been extensively used due to their high efficiency, are particularly susceptible in this respect.

It is therefore highly important to be able to determine charging of individual cells in a charging device. However, designs therefor tend to be disadvantageous, since they are relatively expensive and the components used increase the production costs of a respective rechargeable battery pack.

It is therefore the underlying purpose of the invention to provide a rechargeable battery pack and a method for determining the voltage of individual rechargeable battery cells arranged in series, as well as an electrical hand tool device, which are of simple construction and permit sufficiently exact voltage determination, while reducing component costs.

### SUMMARY OF THE INVENTION

This object is achieved in accordance with the invention by providing a multiplex arrangement in the rechargeable battery pack between the rechargeable battery cells and the electronic unit, wherein the voltage values of the rechargeable battery cells are sequentially tapped in cycles, and the obtained values are transferred to the electronic unit via the multiplex arrangement. The electronic unit can determine the voltage of each instantly measured cell using one single measuring system. In this fashion, only one single measuring amplifier and/or A/D converter is required. In this case, a more precise amplifier may be used, such that the voltage can be determined much more precisely, at the same time reducing costs.

The inventive rechargeable battery cells may, in particular, be lithium cells. Rechargeable lithium batteries are advantageous in that they provide a relatively high energy density, and are therefore particularly suited to supply energy to portable electrical hand tool devices which should have a minimum weight for easy handling, but must guarantee high performance. Lithium ion cells are, however, disadvantageous in that they can no longer be used after complete discharge, in particular, below 2V. On the other hand, overcharging can also damage the cells and, in extreme cases, even cause the cells to explode. For this reason, it is particularly important to exactly determine the charging state in this technology.

The voltage of each individual rechargeable battery cell may moreover be tapped or, if parallel-connected rechargeable battery cells are provided (so-called rechargeable battery blocks), the voltage of each individual rechargeable battery block may be tapped.

In addition to the rechargeable battery pack, the invention also concerns a method for determining the voltages of individual rechargeable battery cells which are disposed in series in a rechargeable battery pack of the above-mentioned type, wherein the potential is initially sequentially determined in cycles upstream of each rechargeable battery cell connected in series, and subsequently downstream of the last rechargeable battery cell, with potential values being passed on to an electronic unit via a multiplex arrangement, wherein the voltage states of the individual rechargeable battery cells or blocks are detected in the electronic unit to determine the charging state.

The potential relative to ground, which is applied upstream of the first series-connected rechargeable battery cell, is thereby initially determined. The potential upstream and thereby also downstream of each further cell is subsequently determined. In this fashion, the voltage across the individual cells is detected in an evaluation unit, i.e. the electronic unit. The charging state can thereby be determined and further charging can be optionally controlled to prevent overcharging of individual cells. Individual cells may moreover be prevented from dropping below a minimum voltage value.

The method may thereby be performed continuously, in particular, when the cells are in the charging state. Alternatively, the method may be performed only at discrete, individual times.

The method may also be requested during operation of the rechargeable battery pack e.g. in an electrical hand tool device. In this fashion, the voltage and thereby also the charging state as well as the remaining operating time can be determined. It is thereby possible to supply the stated values to a charging state display which may be provided on a corresponding rechargeable battery pack or a corresponding electrical hand tool device, to show the user e.g. that the rechargeable battery pack has a remaining rechargeable battery power of 25%, 50%, 75%, or 100%. A continuous display is also feasible. Further display means are an acoustical signal which indicates that only a certain remaining operating time is left.

The invention also concerns an electrical hand tool device comprising a rechargeable battery pack of the above-described type.

Further advantages and features can be obtained from the remaining application documents.

### BRIEF DESCRIPTION OF THE DRAWING

FIG. 1 schematically shows an electrical hand tool (T) having a motor (M) and a rechargeable battery pack (R) in accordance with the invention; and

FIG. 2 illustrates an embodiment of the rechargeable battery pack (R) of FIG. 1 having 4 rechargeable cell units (C1, C2, C3, C4), a multiplexer (M), and an electronic unit (E) having processing means (P).

### DESCRIPTION OF THE PREFERRED EMBODIMENT

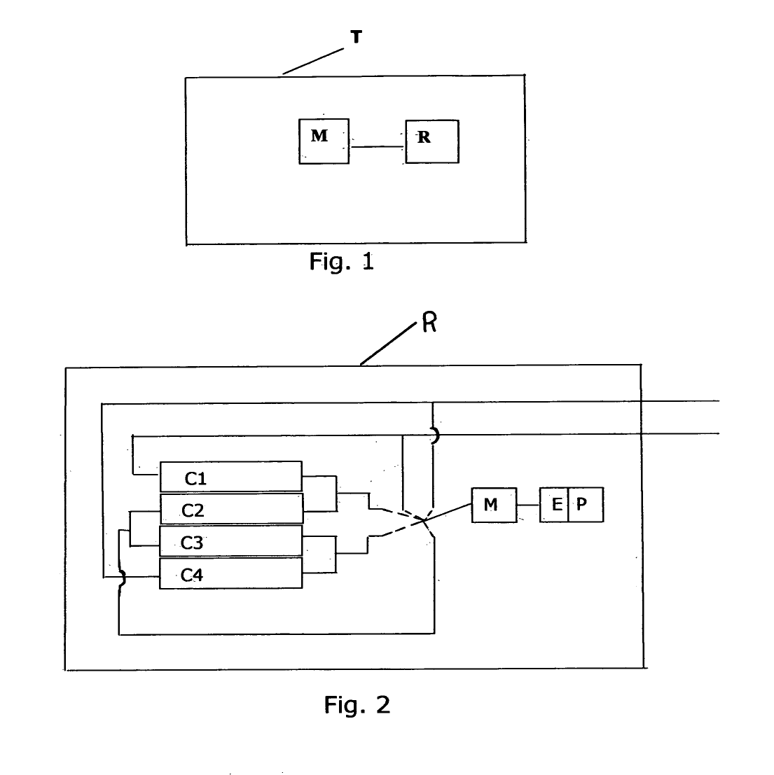

The invention is explained in more detail below with reference to the example of FIGS. 1 and 2. An electrical hand tool device (T), i.e. a percussion drilling machine, is thereby designed as a portable rechargeable battery device. The rechargeable battery pack (R) comprising a rechargeable battery housing, may be mechanically and also electrically locked and contacted with the electrical hand tool device (T). The rechargeable battery pack comprises eight rechargeable battery cells (C1, C2, C3, C4), wherein two rechargeable battery cells are connected in parallel, in each case. This parallel connection is preferably used for lithium ion cells in contrast to e.g. nickel cadmium rechargeable batteries. This connection between two rechargeable battery cells is called a rechargeable battery cell block. Four of these rechargeable battery cell blocks (C1, C2, C3, C4) are connected in series. Each of the rechargeable battery cell blocks (R) is electrically connected to the electronics (E) of the rechargeable battery pack (R). The electronics, including printed circuit board, may thereby be accommodated in an electronic housing, where they are fixed e.g. through casting, in particular, in material fit.

The electronics comprises a multiplexer (M) via which all electronic inputs of the rechargeable battery cells blocks (C1, C2, C3, C4) are guided. The multiplexer is, in turn, connected to a measuring value processing means (P) in the electronics (E).

During operation and also during the charging process of the rechargeable battery pack (R) the potential, relative to ground, is initially continuously determined upstream of the first rechargeable battery cell block (C1). This potential is defined as a comparative potential. The potential downstream of the first rechargeable battery cell block (C1) is subsequently determined with a time delay, wherein the difference gives the voltage across the first rechargeable battery cell block (C1). The potentials downstream of the second rechargeable battery cell block (C2) the third rechargeable battery cell block (C3) and the fourth rechargeable battery cell block (C4) are then sequentially determined with a time delay. The multiplexer (M) switches over from one rechargeable battery cell block to the next. The respective voltage across the individual rechargeable battery cell blocks can be determined by determining the difference with respect to the voltage of the respective previous block. The different charging states during charging and discharging of the rechargeable battery pack (R) can be determined on the basis of this obtained data and is processed using a measuring amplifier, which may have high measuring accuracy.

This data may be used to operate a charging state display which displays the instantaneous charging state e.g. during use of the electrical hand tool device. The display is realized by an optical signal. Moreover, charging of the rechargeable battery pack can be controlled by determining the charging state of the individual rechargeable battery cell blocks, such that all rechargeable battery cell blocks are optimally and maximally charged but none of the individual rechargeable battery cell blocks is overcharged. Corresponding control can be effected e.g. via the charging current.

The charging states of the individual rechargeable battery cells can be determined in a particularly simple and inexpensive fashion as described above.

We claim:

1. A device for determining voltages of individual rechargeable battery cells, arranged in series, in a rechargeable battery pack, the device comprising:
means for a sequentially determining, in cycles, a potential upstream of each series-connected rechargeable battery cell and a potential downstream of a last rechargeable battery cell;
means for passing the potential value to an electronic unit via a multiplex arrangement; and
means for evaluating voltage states of the individual rechargeable battery cells in the electronic unit to determine a charging state.

2. The rechargeable battery pack of claim 1, wherein said rechargeable battery cells are disposed in a rechargeable battery housing and a multiplex arrangement is disposed between said rechargeable battery cells and said electronic unit to tap voltage values of said rechargeable battery cells sequentially and in cycles and to submit obtained values thereof to said electronic unit.

3. The rechargeable battery pack of claim 2, wherein a voltage of each individual rechargeable battery cell or of a rechargeable battery cell block having a plurality of rechargeable battery cells connected in series, can be separately tapped.

4. The rechargeable battery pack of claim 2, wherein said electronic unit comprises a measuring value processing means.

5. The rechargeable battery pack of claim 4, wherein said measuring value processing means comprises an analog/digital converter and/or a measuring amplifier.

6. The rechargeable battery pack of claim 2, wherein said rechargeable battery cells are lithium cells.

7. A method for determining voltages of individual rechargeable battery cells, arranged in series, in a rechargeable battery pack, the method comprising the steps of:
a) sequentially determining, in cycles, a potential upstream of each series-connected rechargeable battery cell and a potential downstream of a last rechargeable battery cell;
b) passing the potential values to an electronic unit via a multiplex arrangement; and
c) evaluating voltage states of the individual rechargeable battery cells in the electronic unit to determine a charging state.

8. The method of claim 7, wherein the method is performed continuously or at discrete times during a charging and/or discharging process.

9. An electrical hand tool device comprising a housing and an electric motor for driving a tool, wherein the electrical hand tool device is structured for mechanical and electrical connection to the rechargeable battery pack of claim 1.
